(19) United States
(12) Patent Application Publication
(10) Pub. No.: US 2024/0070526 A1
(43) Pub. Date: Feb. 29, 2024

(54) COMPUTER-BASED SYSTEMS HAVING TECHNOLOGICALLY IMPROVED MACHINE LEARNING RECOMMENDATION ENGINES CONFIGURED/PROGRAMMED TO UTILIZE DYNAMIC VARIABLE RATIO FEEDBACK AND METHODS OF USE THEREOF

(71) Applicant: Capital One Services, LLC, McLean, VA (US)

(72) Inventors: Samuel Rapowitz, Roswell, GA (US); Bryant Yee, Silver Spring, MD (US); Zachary Sweeney, McLean, VA (US); Steven Black, Arlington, VA (US); Alexander Lin, Baltimore, MD (US); Jenny Melendez, Falls Church, VA (US); Joshua Peters, Charlottesville, VA (US)

(21) Appl. No.: 17/899,355

(22) Filed: Aug. 30, 2022

(51) Int. Cl. G06N 20/00

(52) U.S. Cl. CPC G06N 20/00

(57) ABSTRACT

Systems and methods of the present disclosure enable variable and dynamic feedback to electronic activities by receiving event data and utilizing a feedback machine learning model to predict an average feedback attribute and an average feedback variability attribute based on the event data. A feedback data entry is added to a user profile to store the average feedback attribute and the average feedback variability attribute. A new event and a new event attribute are received for the user profile, and a feedback probability distribution for the new event is generated based on the new event attribute, the average feedback attribute, and the average feedback variability attribute. A new event feedback is generated for the new event based on a random selection from the feedback probability distribution and is output to a computing device associated with the user profile.

### FIELD OF TECHNOLOGY

The present disclosure generally relates to computer-based systems having technologically improved machine learning recommendation engines configured/programmed to utilize dynamic variable ratio feedback, such as, in response to user engagement, and methods of use thereof.

### BACKGROUND OF TECHNOLOGY

Typically, online user engagement (e.g., interaction with a website, an app, etc.) may be measured and computer systems may be programmed to increase user engagement. For example, without limitation, modifications to user profiles, including incentives, include manual and/or rules-based changes, including manually and/or rules-based creation of new data entries associated with electronic activities.

### SUMMARY OF DESCRIBED SUBJECT MATTER

In some aspects, the techniques described herein relate to a method including: receiving, by at least one processor, event data including at least one event data entry that represents at least one event; wherein the at least one event data entry includes at least one event attribute; utilizing, by the at least one processor, a feedback machine learning model to predict an average feedback attribute and an average feedback variability attribute based at least in part on the event data; wherein the average feedback attribute includes an average event feedback percentage; wherein the average feedback variability attribute includes an average event feedback variability percentage; generating, by the at least one processor, a feedback data entry in a user profile to store the average feedback attribute and the average feedback variability attribute in association with the user profile; receiving, by the at least one processor, at least one new event indication associated with the user profile, wherein the at least one new event indication indicates at least one new event and at least one new event attribute of the at least one new event; generating, by the at least one processor, a feedback probability distribution based at least in part on: (i) the at least one new event attribute, (ii) the average feedback attribute, and (iii) the average feedback variability attribute of the feedback data entry; generating, by the at least one processor, a new event feedback for at least one new event based at least in part on: (i) the at least one new event attribute, and (ii) at least one random selection from the feedback probability distribution; and instructing, by the at least one processor, to display the new event feedback for the at least one new event indication on a computing device associated with the user profile.

In some aspects, the techniques described herein relate to a method, further including determining, by the at least one processor, a target variability of the average feedback attribute including at least one of: a maximum feedback rate, a minimum feedback rate, or a number of standard deviations.

In some aspects, the techniques described herein relate to a method, further including generating, by the at least one processor, a user-specific variable rate feedback record linked to the user profile, wherein the user-specific variable rate feedback record includes the average feedback attribute and a target variability attribute specifying the target variability.

In some aspects, the techniques described herein relate to a method, wherein the average feedback attribute includes at least one: a target frequency including an average frequency of applying the new event feedback in response to the at least one new event, or a target feedback quantity an average quantity of the new event feedback in response to the at least one new event.

In some aspects, the techniques described herein relate to a method, further including: determining, by the at least one processor, at least one engagement metric measuring user engagement based at least in part on the at least one new event; comparing, by the at least one processor, the at least one engagement metric with at least one threshold engagement value; and determining, by the at least one processor, a modification to the average feedback attribute based at least in part on comparing the at least one engagement metric with at least one threshold engagement value.

In some aspects, the techniques described herein relate to a method, further including utilizing, by the at least one processor, the feedback machine learning model to determine the modification to the average feedback attribute based at least in part on model parameters and the at least one engagement metric.

In some aspects, the techniques described herein relate to a method, wherein the feedback machine learning model includes at least one reinforcement model.

In some aspects, the techniques described herein relate to a method, further including: producing, by the at least one processor, a training dataset that correlates the event data with previous modifications to the average feedback attribute; and training, by the at least one processor, the feedback machine learning model based at least in part on the training dataset.

In some aspects, the techniques described herein relate to a method, wherein the feedback probability distribution includes a normal distribution.

In some aspects, the techniques described herein relate to a method, wherein the feedback probability distribution includes a gamma distribution.

In some aspects, the techniques described herein relate to a system including: at least one processor configured to execute software instructions, wherein upon execution the software instructions cause the at least one processor to: receive event data including at least one event data entry that represents at least one event; wherein the at least one event data entry includes at least one event attribute; utilize a feedback machine learning model to predict an average feedback attribute and an average feedback variability attribute based at least in part on the event data; wherein the average feedback attribute includes an average event feedback percentage; wherein the average feedback variability attribute includes an average event feedback variability percentage; generate a feedback data entry in a user profile to store the average feedback attribute and the average feedback variability attribute in association with the user profile; receive at least one new event indication associated with the user profile, wherein the at least one new event indication indicates at least one new event and at least one new event attribute of the at least one new event; generate a feedback probability distribution based at least in part on the at least one new event attribute, the average feedback attribute and the average feedback variability attribute of the feedback data entry; generate a new event feedback for at least one new event based at least in part on the at least one new event attribute and at least one random selection from the feedback probability distribution; and instruct to display at least one the new event feedback for the at least one new event indication on a computing device associated with the user profile.

In some aspects, the techniques described herein relate to a system, wherein the at least one processor is further configured to execute software instructions that, upon execution, further cause the at least one processor to determine a target variability of the average feedback attribute include at least one of: a maximum feedback rate, a minimum feedback rate, or a number of standard deviations.

In some aspects, the techniques described herein relate to a system, wherein the at least one processor is further configured to execute software instructions that, upon execution, further cause the at least one processor to generate a user-specific variable rate feedbacks record linked to the user profile, wherein the user-specific variable rate feedbacks record includes the average feedback attribute and a target variability attribute specifying the target variability.

In some aspects, the techniques described herein relate to a system, wherein the average feedback attribute includes at least one: a target frequency include an average frequency of applying the new event feedback in response to the at least one new event, or a target feedback quantity an average quantity of the new event feedback in response to the at least one new event.

In some aspects, the techniques described herein relate to a system, wherein the at least one processor is further configured to execute software instructions that, upon execution, further cause the at least one processor to: determine at least one engagement metric measuring user engagement based at least in part on the at least one new event; compare the at least one engagement metric with at least one threshold engagement value; and determine a modification to the average feedback attribute based at least in part on comparing the at least one engagement metric with at least one threshold engagement value.

In some aspects, the techniques described herein relate to a system, wherein the at least one processor is further configured to execute software instructions that, upon execution, further cause the at least one processor to utilize the feedback machine learning model to determine the modification to the average feedback attribute based at least in part on model parameters and the least one engagement metric.

In some aspects, the techniques described herein relate to a system, wherein the feedback machine learning model includes at least one reinforcement model.

In some aspects, the techniques described herein relate to a system, wherein the at least one processor is further configured to execute software instructions that, upon execution, further cause the at least one processor to: produce a training dataset that correlates the event data with previous modifications to the average feedback attribute; and train the feedback machine learning model based at least in part on the training dataset.

In some aspects, the techniques described herein relate to a system, wherein the feedback probability distribution includes a normal distribution.

In some aspects, the techniques described herein relate to a method including: receiving, by the at least one processor, at least one new event indication associated with a user profile, wherein the at least one new event indication indicates at least one new event and at least one new event attribute of the at least one new event; accessing, by the at least one processor, an average feedback attribute and an average feedback variability attribute associated with the user profile; wherein the average feedback attribute includes an average event feedback percentage; wherein the average feedback variability attribute includes an average event feedback variability percentage; generating, by the at least one processor, a feedback probability distribution based at least in part on: (iv) the at least one new event attribute, (v) the average feedback attribute, and (vi) the average feedback variability attribute of the feedback data entry; generating, by the at least one processor, a new event feedback for at least one new event based at least in part on: (iii) the at least one new event attribute, and (iv) at least one random selection from the feedback probability distribution; and updating, by the at least one processor, the user profile with a feedback score indicative of the new event feedback.

### BRIEF DESCRIPTION OF THE DRAWINGS

Various embodiments of the present disclosure can be further explained with reference to the attached drawings, wherein like structures are referred to by like numerals throughout the several views. The drawings shown are not necessarily to scale, with emphasis instead generally being placed upon illustrating the principles of the present disclosure. Therefore, specific structural and functional details disclosed herein are not to be interpreted as limiting, but merely as a representative basis for teaching one skilled in the art to variously employ one or more illustrative embodiments.

FIG. 1 is a block diagram illustrating an operating computer architecture for dynamic, variable ratio event feedback to a user for improved user engagement response, according to one or more embodiments of the present disclosure.

FIG. 2 is a process flow diagram illustrating an example of a computer-based process for offering dynamic, variable ratio event feedback to a user, according to one or more embodiments of the present disclosure.

FIG. 3 is a process flow diagram illustrating an example of a computer-based process for offering dynamic, variable ratio event feedback including loyalty rewards to a user, according to one or more embodiments of the present disclosure.

FIGS. 4-7 show one or more schematic flow diagrams, certain computer-based architectures, and/or screenshots of various specialized graphical user interfaces which are illustrative of some exemplary aspects of at least some embodiments of the present disclosure.

### DETAILED DESCRIPTION

Various detailed embodiments of the present disclosure, taken in conjunction with the accompanying figures, are disclosed herein; however, it is to be understood that the disclosed embodiments are merely illustrative. In addition, each of the examples given in connection with the various embodiments of the present disclosure is intended to be illustrative, and not restrictive.

Throughout the specification, the following terms take the meanings explicitly associated herein, unless the context clearly dictates otherwise. The phrases “in one embodiment” and “in some embodiments” as used herein do not necessarily refer to the same embodiment(s), though it may. Furthermore, the phrases “in another embodiment” and “in some other embodiments” as used herein do not necessarily refer to a different embodiment, although it may. Thus, as described below, various embodiments may be readily combined, without departing from the scope or spirit of the present disclosure.

In addition, the term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

As used herein, the terms “and” and “or” may be used interchangeably to refer to a set of items in both the conjunctive and disjunctive in order to encompass the full description of combinations and alternatives of the items. By way of example, a set of items may be listed with the disjunctive “or”, or with the conjunction “and.” In either case, the set is to be interpreted as meaning each of the items singularly as alternatives, as well as any combination of the listed items.

As used herein, the term “customer” or “user” shall have a meaning of at least one customer or at least one user respectively.

As used herein, the term “organization” may be used interchangeably with the terms: “bank”, “financial institution”, “company”, “business”, “entity”, and the like.

As used herein, the term “reward” may be used interchangeably with the terms: “reward point”, “credit”, “point”, “reward credits”, and the like.

As used herein, the term “mobile computing device” or the like, may refer to any portable electronic device that may include relevant software and hardware. For example, a “mobile computing device” can include, but is not limited to, any electronic computing device that is able to among other things receive and process alerts, credit offers, credit requests, and credit terms from a customer or financial institution including, but not limited to, a mobile phone, smart phone, or any other reasonable mobile electronic device that may or may not be enabled with a software application (App) from the customer's financial institution.

In some embodiments, a “mobile computing device” may include computing devices that typically connect using a wireless communications medium such as cell phones, smart phones, tablets, laptops, computers, pagers, radio frequency (RF) devices, infrared (IR) devices, CBs, integrated devices combining one or more of the preceding devices, or virtually any mobile computing device that may use an application, software or functionality to receive and process alerts, rewards offers, rewards terms from a customer or financial institution.

As used herein, term “server” should be understood to refer to a service point which provides processing, database, and communication facilities. By way of example, and not limitation, the term “server” can refer to a single, physical processor with associated communications and data storage and database facilities, or it can refer to a networked or clustered complex of processors and associated network and storage devices, as well as operating software and one or more database systems and application software that support the services provided by the server. Cloud servers are examples.

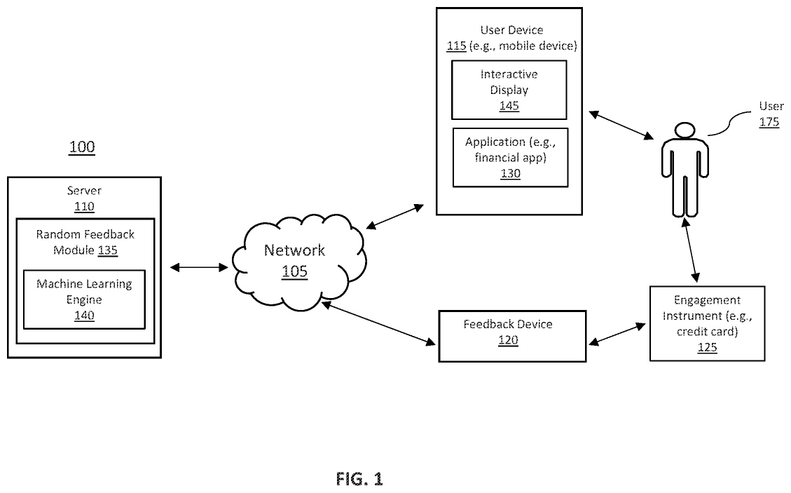

FIGS. 1 through 7 illustrate systems and methods of offering dynamic, variable ratio updates to a user profile. The following embodiments provide technical solutions and technical improvements that overcome technical problems, drawbacks and/or deficiencies in the technical fields involving user profile management, data management and/or content recommendation. As explained in more detail, below, technical solutions and technical improvements herein include aspects of improved user profile management, data management and/or content recommendation via dynamic and/or variable feedback mechanisms to generate new inputs including new data entries and/or new recommended content, thus avoiding static data and/or overfitting of feedback to a user and/or to a machine learning model for predicting recommendation content. Based on such technical features, further technical benefits become available to users and operators of these systems and methods. Moreover, various practical applications of the disclosed technology are also described, which provide further practical benefits to users and operators that are also new and useful improvements in the art.

According to some embodiments, there are provided exemplary computer-based systems and computer-based methods that utilize an exemplary technologically improved predictive engine of the present disclosure that would be configured/programmed for awarding dynamic, variable-ratio rewards (e.g., feedbacks) randomly in a reward program associated with a user profile. In some embodiments, feedback may be set according to an average feedback based on user data, such as, e.g., spending behavior, content consumption, electronic activities (e.g., browsing data, etc.) among other user profile data. In some embodiments, feedback may be generated to have variable values and/or content that may average to the average feedback. Such variable feedback may automatically adjust in response to data entries in the user profile and may avoid overfitting to a particular feedback (e.g., value and/or content) and improve user engagement with, for example, without limitations, financial services, merchants, products, online content, content recommendation, etc. by providing randomized content that is within a predetermined variability of a predetermined average target. Thus, the variable feedback mechanism described herein overcome problems inherent to content recommendation that results in overfitting and/or static content by adding a layer of confined randomization. Such content may include media content recommendations, social media recommendations, rebate and/or reward recommendations, promotions and/or sales recommendations, among other content provided to a user in response to the activities and behavior of the user in electronic environments.

The variable and dynamic nature of the feedback provides constantly changing stimulus to content recommendation models, user profiles, and the users themselves, thus increasing the likelihood that the user would engage with a particular online service/app. For example, the recommendation feedback may be in the form of rebates and/or rewards in response to spending with a credit card. Ordinarily, such rewards are static and preset. By adding in an exemplary variable feedback mechanism of at least some embodiments of the present disclosure, the rewards may be constantly varied, e.g., randomly or algorithmically, such that the rewards average to a particular rewards level, but provide an added stimulus to the user that incentivizes greater online engagement.

FIG. 1 is a block diagram illustration of an exemplary illustrative feedback system 100 used to implement one or more embodiments of the present disclosure. The components and arrangements shown in FIG. 1 are not intended to limit the disclosed embodiments as the components used to implement the disclosed processes and features may vary. In accordance with disclosed embodiments, the feedback system 100 may include a server 110 in communication with a user device 115 and a feedback device 120 and various other systems (not shown) such as additional banking/financial systems, which may interact via a network 105. In some embodiments, the feedback system 100 is associated with a service for which feedback may influence content provided to the user 175. In some embodiments, the feedback system 100 also includes an engagement instrument 125.

In some embodiments, the server 110 may be associated with any organization or business that utilizes or interacts with the service associated with the feedback system 100. In some embodiments, the server 110 is associated with a financial institution. For example, server 110 may process financial transactions, or manage individual profiles. In some embodiments, the server 110 may be associated with a content distribution service. For example, server 110 may include a content recommendation engine that provides recommended to content to users. One of ordinary skill will recognize that server 110 may include one or more logically or physically distinct systems. As further described herein, the server 110 may perform operations (or methods, functions, processes, etc.) that may require access to one or more peripherals and/or modules. In the example of FIG. 1, the activity server 110 includes a random feedback module 135.

In some embodiments, the server 110 may include hardware components such as a processor (not shown), which may execute instructions that may reside in local memory and/or transmitted remotely. In some embodiments, the processor may include any type of data processing capacity, such as a hardware logic circuit, for example, an application specific integrated circuit (ASIC) and a programmable logic, or such as a computing device, for example a microcomputer or microcontroller that includes a programmable microprocessor.

Examples of hardware components may include one or more processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. In some embodiments, the one or more processors may be implemented as a Complex Instruction Set Computer (CISC) or Reduced Instruction Set Computer (RISC) processors; x86 instruction set compatible processors, multi-core, or any other microprocessor or central processing unit (CPU). In various implementations, the one or more processors may be dual-core processor(s), dual-core mobile processor(s), and so forth.

In some embodiments, the user device 115 is a mobile computing device. The user device 115, or mobile user device, may generally include at least computer-readable non-transient medium, a processing component, an Input/Output (I/O) subsystem and wireless circuitry. These components may be coupled by one or more communication buses or signal lines. The user device 115 may be any portable electronic device, including a handheld computer, a tablet computer, a mobile phone, laptop computer, tablet device, a multi-function device, a portable gaming device, a vehicle display device, or the like, including a combination of two or more of these items.

It should be apparent that the architecture described is only one example of an architecture for the user device 115, and that user device 115 can have more or fewer components than shown, or a different configuration of components. The various components described above can be implemented in hardware, software, or a combination of both hardware and software, including one or more signal processing and/or application specific integrated circuits.

In some embodiments, the wireless circuitry is used to send and receive information over a wireless link or network to one or more other devices' suitable circuitry such as an antenna system, an RF transceiver, one or more amplifiers, a tuner, one or more oscillators, a digital signal processor, a CODEC chipset, memory, etc. The wireless circuitry can use various protocols, e.g., as described herein.

In some embodiments, the user device 115 may be associated with a user 175 who is authorized to use a profile (e.g., a profile holder or authorized user) such as a financial profile (e.g., a credit card profile), an internet profile, a social media profile, etc. In some embodiments, when a user performs an electronic activity, such as viewing or requesting content, sending messages, executing a transaction, etc., a data entry recording the electronic activity may be added to an event record of the user profile. In some embodiments, feedback parameters associated with the feedback program are added to the user profile. In some embodiments, when feedback is provided, the feedback may be added to the user profile as a new data entry in the event record or as a modification to one or more parameters associated with the user profile, or any suitable combination thereof.

In some embodiments, the user device 115 may include an application such as an application 130 (or application software) which may include program code (or a set of instructions) that performs various operations (or methods, functions, processes, etc.), as further described herein. In some embodiments, the application 130 may enable users to access, view, and/or manage event data (e.g., user engagement or transaction data) for an existing user profile of the user. For example, in some embodiments, application 130 may display the user's transaction history with details about each completed transaction in a financial profile transaction record.

Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

As shown in FIG. 1, in some embodiments, the user device 115 may be a mobile computing device that includes an interactive display 145. In some embodiments, the application 130 may be an application provided by the financial entity. In some implementations, the application 130 may be automatically installed onto the user device 115 after being downloaded. In addition, in some embodiments, the application 130 or a component thereof may reside (at least partially) on a remote system (e.g., server 110) with the various components residing on the user device 115.

In some embodiments, the engagement instrument 125 may be used by the user 175 to engage in the rewards program. For example, in some embodiments, the engagement instrument 125 may be a credit card, a debit card, a smart card, a cellular phone, the user device 115, a software application, an internet browser, etc. The engagement instrument 125 may be, for example, a credit card associated with the rewards program of the feedback system 100 used to make a qualifying purchase.

In some embodiments, the feedback device 120 may be any device that is configured to communicate with the feedback system 100. For example, feedback device 120 may be, e.g., a content delivery network, a social media service, a point-of-sale (POS) device, kiosk, cell phone, etc. Feedback device 120 may transmit identifying information from the engagement instrument 125 to the server 110. In some embodiments, the feedback device 120 may further transmit new event data for an event that has taken place with the user. For example, the feedback device 120 may transmit data related to a new transaction (e.g., a purchase using a credit card), a content download or stream, a social media post, etc. In some embodiments, the feedback device 120 may communicate with the engagement instrument 125. For example, in some embodiments, the engagement instrument 125 including a credit card for a rewards program, the engagement instrument 125 may be inserted into a suitable card reading device coupled to the feedback device 120, scanned etc.

In some embodiments, the feedback system 100 generates random feedback based on the new event by the user. In some embodiments, the new event may be any activity that is pre-established by the feedback system 100 as a qualifying event. In some embodiments, a qualifying event is determined by a credit card issuer of a credit card that is associated with the feedback system 100. In some embodiments, a qualifying event is a transaction completed by the user using a credit card. In some embodiments, what constitutes a qualifying event may be determined by the specific credit card held by the user 175. For example, in some embodiments, the credit card may only provide rewards on travel-related purchases (e.g., flights, hotel, etc.) or on groceries. In some embodiments, the credit card may provide rewards for purchases over a predetermined amount. For example, a qualifying event may be any purchase over $50.

Once the user completes the new event, the user profile may be modified with the dynamic, variable feedback. In some embodiments, the user profile is modified with dynamic, variable feedback each time the user engages in an electronic activity that generates a new event that is a qualifying event. For example, every time a purchase over $50 is made.

In some embodiments, the dynamic, variable feedback may be generated by the random feedback module 135 based on a dynamic, variable-ratio feedback structure. In some embodiments, the random feedback module 135 may be implemented as an application (or set of instructions) or software/hardware combination configured to perform operations for generating random feedback for new events. In some embodiments, in order for the random feedback module 135 to provide randomized feedback, the feedback system 100 may determine an average event feedback percentage and an average event feedback variability percentage for a user based on a variety of user data, as will be explained in further detail below.

In some embodiments, the average event feedback percentage may be a target average feedback value or target average percentage of an amount or quantity associated with a new event. Thus, over time, the event feedback on each new event may average to the average event feedback percentage. In some embodiments, the average event feedback percentage may be a percentage of the purchase value that the user will get back as points or miles, an adjustment to a time spent viewing video or interactive online content, among other feedback values. For example, the average event feedback percentage may be a percentage of the purchase value that the user will get as cash back. For example, in a cash back event feedback program, the average event feedback percentage may be 10% of the purchase value of a qualifying purchase. Thus, in this example, while the specific event feedback provided on each qualifying transaction may vary, as will be described in further detail below, over time, an average value of the event feedback provided on qualifying transactions will be 10% of the qualifying transactions.

In some embodiments, the average event feedback percentage may be based on a variety of user data such as, for example, user spending patterns, user event feedback level, event feedback associated with the credit card or other service associated with the user, or by any other suitable event feedback determination. In an example embodiment, the user data may be evaluated in order to determine an event feedback eligibility for a number of event feedback options where the determined event feedback options are further optimized by the inclusion of a behavior analysis. The behavior analysis may take into consideration past activities, event feedback and/or response to event feedback, as well as any other electronic activity-related behaviors in order to provide optimal feedback to a user.

In some embodiments, the average event feedback percentage includes a target frequency including an average frequency of applying at least one new reward in response to at least one new transaction. In some embodiments, the average event feedback percentage includes a target reward quantity that includes an average quantity of at least one new reward in response to the at least one new transaction.

In some embodiments, the average event feedback variability percentage may be the desired range of variation of each event feedback from the average event feedback percentage. In some embodiments, the average event feedback variability percentage may be a predetermined, set range, having a minimum event feedback level and a maximum event feedback level, such as, e.g., a minimum value/amount/quantity/magnitude and a maximum value/amount/quantity/magnitude. For example, in some embodiments, the average event feedback variability percentage may be 10% from the average event feedback percentage in the example of a rewards value for customer spending. Thus, in this example, if the average event feedback percentage is 10%, with the average event feedback variability percentage being 10%, the user may receive event feedback of anywhere from a minimum of 9% (i.e., 10% less than the average event feedback percentage) to a maximum of 11% (i.e., 10% more than the average event feedback percentage) of the purchase value of the qualifying transaction. Therefore, in this example, if the qualifying purchase is $10, the user may receive anywhere from $0.9 to $1.1 in event feedback. In some embodiments, the average event feedback variability percentage may be expressed as a percent variability, absolute value variability, magnitude variability, standard deviation, or any other suitable expression of variability including a minimum and a maximum.

In some embodiments, the random feedback module 135 may employ a machine learning engine 140 to predict the average event feedback percentage and the average event feedback variability percentage based on the user event data (i.e., transaction record) and attributes of the events. In some embodiments, the attributes may include, e.g., a user identifier associated with each data entry, a third-party entity identifier associated with each data entry, an activity type identifier, an activity value or activity quantity, a time data item, a location data item, a date data item, a device type or device identifier associated with the electronic activity execution device 101, an activity description, or other attributes representing characteristics of each data entry. For example, the user event data may include historical transaction data entries related to past transactions completed by the user 175. Attributes of the event data for historical transaction data entries may include, e.g., a transaction value, a transaction type, an account identifier or a user identifier or both, a merchant identifier, a transaction authorization date, a transaction post date, a transaction location, an execution device (e.g., point-of-sale device, Internet payment, etc.) among other transaction data and combinations thereof.

In some embodiments, the event feedback machine learning engine 140 may include, e.g., software, hardware and/or a combination thereof. In some embodiments, the event feedback machine learning engine 140 may include a processor and a memory, the memory having instructions stored thereon that cause the processor to determine, without limitation, at least the average event feedback percentage and the average event feedback variability percentage from the user event data.

In some embodiments, the event feedback machine learning engine 140 may be configured to utilize one or more machine learning techniques chosen from, but not limited to, decision trees, boosting, support-vector machines, neural networks, nearest neighbor algorithms, Naive Bayes, bagging, random forests, and the like. In some embodiments and, optionally, in combination of any embodiment described above or below, an exemplary neutral network technique may be one of, without limitation, feedforward neural network, radial basis function network, recurrent neural network, convolutional network (e.g., U-net) or other suitable network. In some embodiments and, optionally, in combination of any embodiment described above or below, an exemplary implementation of Neural Network may be executed as follows:
i) Define Neural Network architecture/model,
ii) Transfer the input data to the exemplary neural network model,
iii) Train the exemplary model incrementally,
iv) determine the accuracy for a specific number of timesteps,
v) apply the exemplary trained model to process the newly-received input data,
vi) optionally and in parallel, continue to train the exemplary trained model with a predetermined periodicity.

In some embodiments, the average event feedback percentage and the average event feedback variability percentage for a user are pre-determined values that are stored on the server 110 as an event feedback data entry associated with the user's profile. Thus, every subsequent qualifying event will be subject to the average event feedback percentage and average event feedback variability percentage.

In some embodiments, the event feedback data entry is dynamically adjustable. For example, in some embodiments, the average event feedback percentage and/or the average event feedback variability percentage may be adjusted by the organization with which the user's profile is associated. In some embodiments, the event feedback data entry is adjusted based on at least one user engagement metric, including spending behavior, click rates, content view time, revisit or re-click rates, fast forward and/or rewind behavior, message size, messaging rates, among other metrics related to electronic activities and user behaviors. In some embodiments, the at least one user engagement metric measures the user's engagement with the event feedback program based on, for example, new events or transactions, the frequency of spending by the user, an average dollar amount of spending, etc. In some embodiments, the at least one user engagement metric may be compared to a pre-determined threshold engagement value. In some embodiments, the pre-determined threshold engagement value may be set by the organization or business that issued the engagement instrument 125 (e.g., credit card). In other embodiments, the pre-determined threshold engagement value may be a set rule of the event feedback program.

In some embodiments, the average event feedback percentage may be modified based on the comparing of the at least one user engagement metric with the threshold engagement value. In some embodiments, the average event feedback percentage may be increased or decreased. For example, if the frequency or amount of spending by the user is lower than the threshold frequency or amount of spending, the average event feedback percentage may be decreased to encourage the user to return to a more responsible level of spending. Conversely, if the frequency or amount of spending by the user is higher than the threshold frequency or amount of spending, the average event feedback percentage may be increased to encourage a higher level of spending by the user.

In some embodiments, the exemplary event feedback machine learning engine 140 may be employed to determine the modification to the average event feedback percentage based on the at least one user engagement metric. In some embodiments, the machine learning engine 140 is trained to determine the modification to the average event feedback percentage using a training dataset that correlates past spending behavior, including event (e.g., transaction, content consumption, social media participation, etc.) data, of the user with past modifications to the average event feedback percentage. For example, the training dataset may include instances where the user's spending behavior resulted in a modification of increasing the average event feedback percentage as well as instances where the user's spending behavior resulted in a modification of decreasing the average event feedback percentage. In some embodiments, the machine learning engine includes at least one reinforcement model.

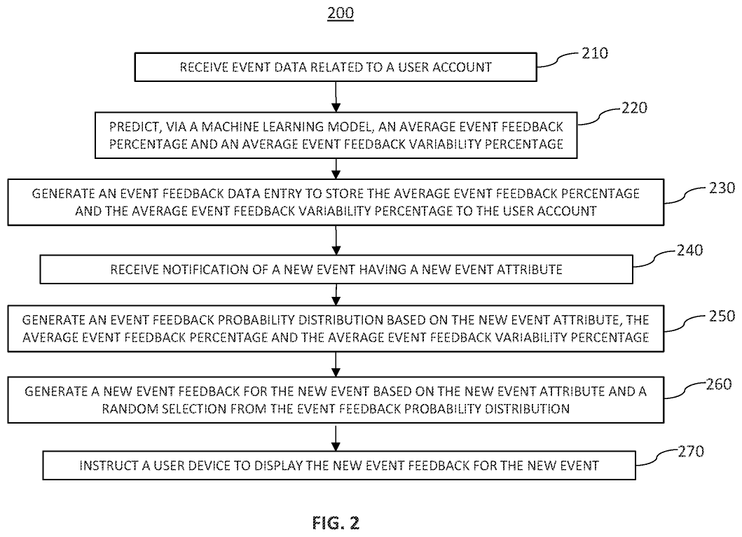

FIG. 2 is a process flow diagram illustration of an example of an illustrative computer-mediated process for generating a dynamic variable ratio credit card rewards for a user 175 according to one or more embodiments of the present disclosure. The exemplary computer-mediated process 200 may be executed by software, hardware, or a combination thereof. For example, process 200 may be performed by including one or more components described in the feedback system 100 of FIG. 1 (e.g., server 110, user device 115 and feedback device 120).

In 210, the exemplary computer-based system (e.g., the server 110) may receive event data including at least one event data entry that represents at least one event (i.e., instance of user engagement, transaction). For example, in some embodiments, the server 110 may receive a transaction record related to a financial profile, as a credit card profile, of the user 175.

In 220, a machine learning model is utilized to predict an average event feedback percentage and an average event feedback variability percentage based at least in part on the transaction data.

In 230, a event feedback data entry is generated in the user profile to store the average event feedback percentage and the average event feedback variability percentage generated by the machine learning model to the user profile. The average event feedback percentage and average event feedback variability percentage will be applied to each new qualifying event completed by the user 175.

In 240, a notification of a new event/electronic activity associated with the user profile is received. In some embodiments, the new event notification indicates that a new event/electronic activity was completed by the user 175. In some embodiments, the notification may be provided by the feedback device 120, where the new event was completed by the user 175. In some embodiments, the new event notification also indicates at least one attribute or characteristic of the new event (i.e., new event attribute). In some embodiments, the new event attribute may be a characteristic that qualifies the new event for the event feedback program. For example, the at least one new event attribute may be that the event amount greater than the threshold amount to qualify an event for event feedback.

In 250, an event feedback probability distribution (i.e., feedback probability distribution) is generated based at least in part on the at least one new event attribute, the average event feedback percentage and the average event feedback variability percentage of the event feedback data entry. Specifically, the event feedback probability distribution provides the probabilities of occurrences of different event feedback values for the at least one new event within the parameters of the pre-determined average event feedback percentage and average event feedback variability percentage. In some embodiments, the event feedback probability distribution is a normal distribution. In some embodiments, the event feedback probability distribution is a gamma distribution.

In 260, a new reward is generated for the at least one new event. In some embodiments, the new event feedback is based at least in part on the at least one new event attribute and at least one random selection from the event feedback probability distribution. Thus, an event feedback may only be generated if the new event is a qualifying event.

In 270, the user device 115 associated with the user profile is instructed to display the new event feedback for the new qualifying event.

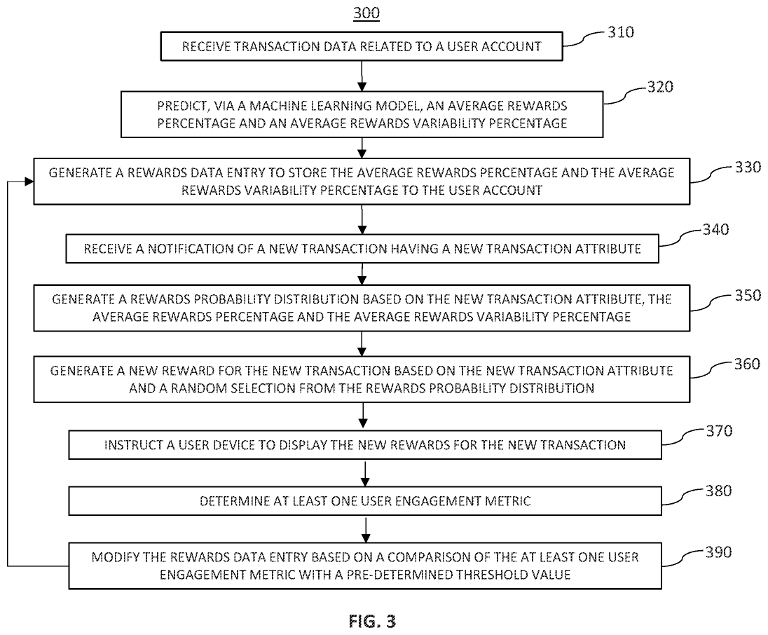

FIG. 3 is a process flow diagram illustration of an example of an illustrative computer-mediated process for generating a dynamic variable ratio credit card rewards for a user 175 according to one or more embodiments of the present disclosure. The exemplary computer-mediated process 200 may be executed by software, hardware, or a combination thereof. For example, process 300 may be performed by including one or more components described in the feedback system 100 of FIG. 1 (e.g., server 110, user device 115 and feedback device 120).

In some embodiments, the process 300 may include the steps of as the process 200 and may further include steps in which the average feedback percentage is dynamically modified.

In 380, at least one user engagement metric measuring the user's engagement with the rewards program is determined based at least in part on the at least one new transaction (i.e., new event). As discussed above, the at least one user engagement metric measures the user's engagement with the rewards program based on, for example, new events or transactions, the frequency of spending by the user, an average dollar amount of spending, etc.

In 390, the average rewards percentage (i.e., average feedback attribute) is modified based on a comparison of the at least one engagement metric with at least one pre-determined threshold engagement value. In some embodiments, as discussed above, the machine learning model is used to determine the modification to the average rewards percentage.

Once the average rewards percentage is modified, the process returns to step 330, where rewards data entry is updated to include the modified average rewards percentage.

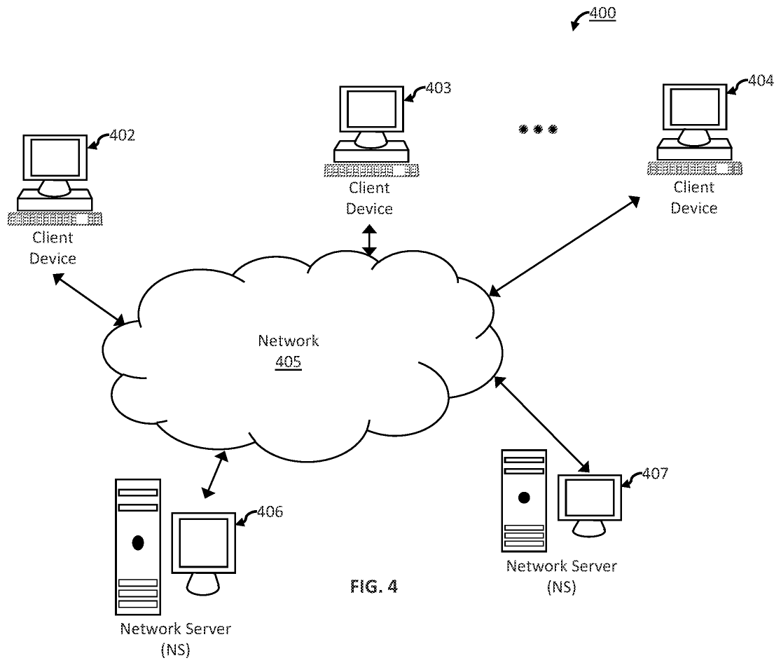

FIG. 4 depicts a block diagram of an exemplary computer-based system and platform 400 in accordance with one or more embodiments of the present disclosure. However, not all of these components may be required to practice one or more embodiments, and variations in the arrangement and type of the components may be made without departing from the spirit or scope of various embodiments of the present disclosure. In some embodiments, the illustrative computing devices and the illustrative computing components of the exemplary computer-based system and platform 400 may be configured to manage a large number of members and concurrent transactions, as detailed herein. In some embodiments, the exemplary computer-based system and platform 400 may be based on a scalable computer and network architecture that incorporates varies strategies for assessing the data, caching, searching, and/or database connection pooling. An example of the scalable architecture is an architecture that is capable of operating multiple servers.

In some embodiments, referring to FIG. 4, member computing device 402, member computing device 403 through member computing device 404 (e.g., clients) of the exemplary computer-based system and platform 400 may include virtually any computing device capable of receiving and sending a message over a network (e.g., cloud network), such as network 405, to and from another computing device, such as servers 406 and 407, each other, and the like. In some embodiments, the member devices 402-404 may be personal computers, multiprocessor systems, microprocessor-based or programmable consumer electronics, network PCs, and the like. In some embodiments, one or more member devices within member devices 402-404 may include computing devices that typically connect using a wireless communications medium such as cell phones, smart phones, pagers, walkie talkies, radio frequency (RF) devices, infrared (IR) devices, CB-s citizens band radio, integrated devices combining one or more of the preceding devices, or virtually any mobile computing device, and the like. In some embodiments, one or more member devices within member devices 402-404 may be devices that are capable of connecting using a wired or wireless communication medium such as a PDA, POCKET PC, wearable computer, a laptop, tablet, desktop computer, a netbook, a video game device, a pager, a smart phone, an ultra-mobile personal computer (UMPC), and/or any other device that is equipped to communicate over a wired and/or wireless communication medium (e.g., NFC, RFID, NBIOT, 3G, 4G, 5G, GSM, GPRS, WiFi, WiMax, CDMA, OFDM, OFDMA, LTE, satellite, ZigBee, etc.). In some embodiments, one or more member devices within member devices 402-404 may include may run one or more applications, such as Internet browsers, mobile applications, voice calls, video games, videoconferencing, and email, among others. In some embodiments, one or more member devices within member devices 402-404 may be configured to receive and to send web pages, and the like.

In some embodiments, an exemplary specifically programmed browser application of the present disclosure may be configured to receive and display graphics, text, multimedia, and the like, employing virtually any web based language, including, but not limited to Standard Generalized Markup Language (SMGL), such as HyperText Markup Language (HTML), a wireless application protocol (WAP), a Handheld Device Markup Language (HDML), such as Wireless Markup Language (WML), WMLScript, XML, JavaScript, and the like. In some embodiments, a member device within member devices 402-404 may be specifically programmed by either Java, .Net, QT, C, C++, Python, PUP and/or other suitable programming language. In some embodiment of the device software, device control may be distributed between multiple standalone applications. In some embodiments, software components/applications can be updated and redeployed remotely as individual units or as a full software suite. In some embodiments, a member device may periodically report status or send alerts over text or email. In some embodiments, a member device may contain a data recorder which is remotely downloadable by the user using network protocols such as FTP, SSH, or other file transfer mechanisms. In some embodiments, a member device may provide several levels of user interface, for example, advance user, standard user. In some embodiments, one or more member devices within member devices 402-404 may be specifically programmed include or execute an application to perform a variety of possible tasks, such as, without limitation, messaging functionality, browsing, searching, playing, streaming or displaying various forms of content, including locally stored or uploaded messages, images and/or video, and/or games.

In some embodiments, the exemplary network 405 may provide network access, data transport and/or other services to any computing device coupled to it. In some embodiments, the exemplary network 405 may include and implement at least one specialized network architecture that may be based at least in part on one or more standards set by, for example, without limitation, Global System for Mobile communication (GSM) Association, the Internet Engineering Task Force (IETF), and the Worldwide Interoperability for Microwave Access (WiMAX) forum. In some embodiments, the exemplary network 405 may implement one or more of a GSM architecture, a General Packet Radio Service (GPRS) architecture, a Universal Mobile Telecommunications System (UMTS) architecture, and an evolution of UMTS referred to as Long Term Evolution (LTE). In some embodiments, the exemplary network 405 may include and implement, as an alternative or in conjunction with one or more of the above, a WiMAX architecture defined by the WiMAX forum. In some embodiments and, optionally, in combination of any embodiment described above or below, the exemplary network 405 may also include, for instance, at least one of a local area network (LAN), a wide area network (WAN), the Internet, a virtual LAN (VLAN), an enterprise LAN, a layer 3 virtual private network (VPN), an enterprise IP network, or any combination thereof. In some embodiments and, optionally, in combination of any embodiment described above or below, at least one computer network communication over the exemplary network 405 may be transmitted based at least in part on one of more communication modes such as but not limited to: NFC, RFID, Narrow Band Internet of Things (NBIOT), ZigBee, 3G, 4G, 5G, GSM, GPRS, WiFi, WiMax, CDMA, OFDM, OFDMA, LTE, satellite and any combination thereof. In some embodiments, the exemplary network 405 may also include mass storage, such as network attached storage (NAS), a storage area network (SAN), a content delivery network (CDN) or other forms of computer or machine readable media.

In some embodiments, the exemplary server 406 or the exemplary server 407 may be a web server (or a series of servers) running a network operating system, examples of which may include but are not limited to Apache on Linux or Microsoft IIS (Internet Information Services). In some embodiments, the exemplary server 406 or the exemplary server 407 may be used for and/or provide cloud and/or network computing. Although not shown in FIG. 4, in some embodiments, the exemplary server 406 or the exemplary server 407 may have connections to external systems like email, SMS messaging, text messaging, ad content providers, etc. Any of the features of the exemplary server 406 may be also implemented in the exemplary server 407 and vice versa.

In some embodiments, one or more of the exemplary servers 406 and 407 may be specifically programmed to perform, in non-limiting example, as authentication servers, search servers, email servers, social networking services servers, Short Message Service (SMS) servers, Instant Messaging (IM) servers, Multimedia Messaging Service (MMS) servers, exchange servers, photo-sharing services servers, advertisement providing servers, financial/banking-related services servers, travel services servers, or any similarly suitable service-base servers for users of the member computing devices 401-404.

In some embodiments and, optionally, in combination of any embodiment described above or below, for example, one or more exemplary computing member devices 402-404, the exemplary server 406, and/or the exemplary server 407 may include a specifically programmed software module that may be configured to send, process, and receive information using a scripting language, a remote procedure call, an email, a tweet, Short Message Service (SMS), Multimedia Message Service (MMS), instant messaging (IM), an application programming interface, Simple Object Access Protocol (SOAP) methods, Common Object Request Broker Architecture (CORBA), HTTP (Hypertext Transfer Protocol), REST (Representational State Transfer), SOAP (Simple Object Transfer Protocol), MLLP (Minimum Lower Layer Protocol), or any combination thereof.

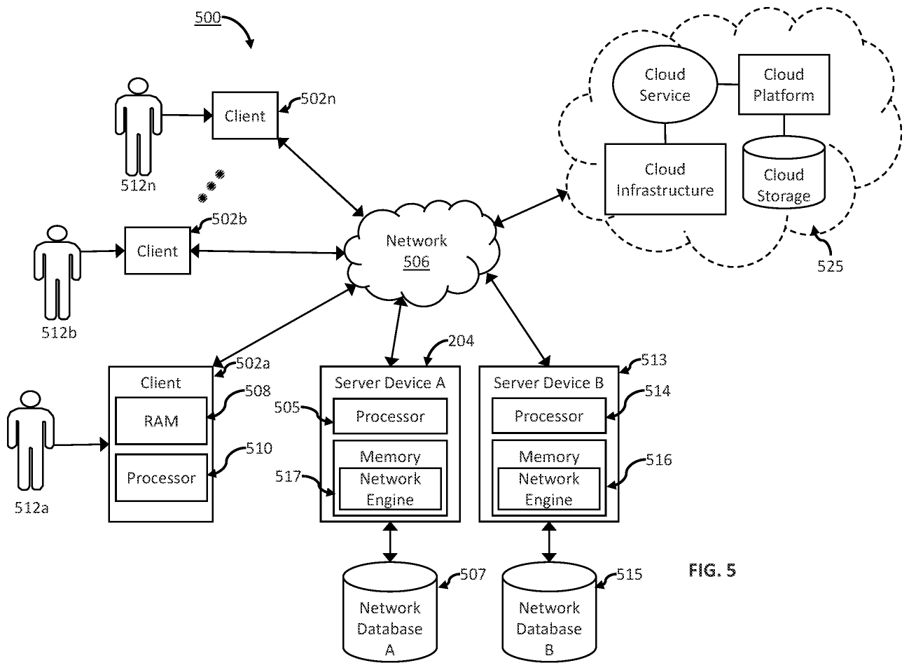

FIG. 5 depicts a block diagram of another exemplary computer-based system and platform 500 in accordance with one or more embodiments of the present disclosure. However, not all of these components may be required to practice one or more embodiments, and variations in the arrangement and type of the components may be made without departing from the spirit or scope of various embodiments of the present disclosure. In some embodiments, the member computing device 502a, member computing device 502b through member computing device 502n shown each at least includes a computer-readable medium, such as a random-access memory (RAM) 508 coupled to a processor 510 or FLASH memory. In some embodiments, the processor 510 may execute computer-executable program instructions stored in memory 508. In some embodiments, the processor 510 may include a microprocessor, an ASIC, and/or a state machine. In some embodiments, the processor 510 may include, or may be in communication with, media, for example computer-readable media, which stores instructions that, when executed by the processor 510, may cause the processor 510 to perform one or more steps described herein. In some embodiments, examples of computer-readable media may include, but are not limited to, an electronic, optical, magnetic, or other storage or transmission device capable of providing a processor, such as the processor 510 of client 502a, with computer-readable instructions. In some embodiments, other examples of suitable media may include, but are not limited to, a floppy disk, CD-ROM, DVD, magnetic disk, memory chip, ROM, RAM, an ASIC, a configured processor, all optical media, all magnetic tape or other magnetic media, or any other medium from which a computer processor can read instructions. Also, various other forms of computer-readable media may transmit or carry instructions to a computer, including a router, private or public network, or other transmission device or channel, both wired and wireless. In some embodiments, the instructions may comprise code from any computer-programming language, including, for example, C, C++, Visual Basic, Java, Python, Perl, JavaScript, and etc.

In some embodiments, member computing devices 502a through 502n may also comprise a number of external or internal devices such as a mouse, a CD-ROM, DVD, a physical or virtual keyboard, a display, or other input or output devices. In some embodiments, examples of member computing devices 502a through 502n (e.g., clients) may be any type of processor-based platforms that are connected to a network 506 such as, without limitation, personal computers, digital assistants, personal digital assistants, smart phones, pagers, digital tablets, laptop computers, Internet appliances, and other processor-based devices. In some embodiments, member computing devices 502a through 502n may be specifically programmed with one or more application programs in accordance with one or more principles/methodologies detailed herein. In some embodiments, member computing devices 502a through 502n may operate on any operating system capable of supporting a browser or browser-enabled application, such as Microsoft™ Windows™, and/or Linux. In some embodiments, member computing devices 502a through 502n shown may include, for example, personal computers executing a browser application program such as Microsoft Corporation's Internet Explorer™, Apple Computer, Inc.'s Safari™, Mozilla Firefox, and/or Opera. In some embodiments, through the member computing client devices 502a through 502n, user 512a, user 512b through user 512n, may communicate over the exemplary network 506 with each other and/or with other systems and/or devices coupled to the network 506. As shown in FIG. 5, exemplary server devices 504 and 513 may include processor 505 and processor 514, respectively, as well as memory 517 and memory 516, respectively. In some embodiments, the server devices 504 and 513 may be also coupled to the network 506. In some embodiments, one or more member computing devices 502a through 502n may be mobile clients.

In some embodiments, at least one database of exemplary databases 507 and 515 may be any type of database, including a database managed by a database management system (DBMS). In some embodiments, an exemplary DBMS-managed database may be specifically programmed as an engine that controls organization, storage, management, and/or retrieval of data in the respective database. In some embodiments, the exemplary DBMS-managed database may be specifically programmed to provide the ability to query, backup and replicate, enforce rules, provide security, compute, perform change and access logging, and/or automate optimization. In some embodiments, the exemplary DBMS-managed database may be chosen from Oracle database, IBM DB2, Adaptive Server Enterprise, FileMaker, Microsoft Access, Microsoft SQL Server, MySQL, PostgreSQL, and a NoSQL implementation. In some embodiments, the exemplary DBMS-managed database may be specifically programmed to define each respective schema of each database in the exemplary DBMS, according to a particular database model of the present disclosure which may include a hierarchical model, network model, relational model, object model, or some other suitable organization that may result in one or more applicable data structures that may include fields, records, files, and/or objects. In some embodiments, the exemplary DBMS-managed database may be specifically programmed to include metadata about the data that is stored.

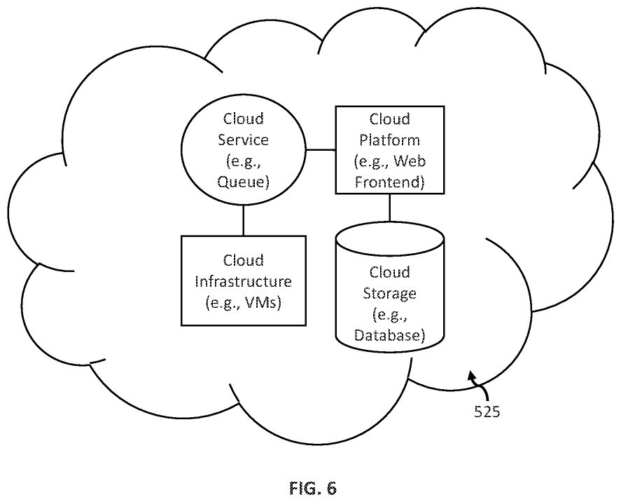

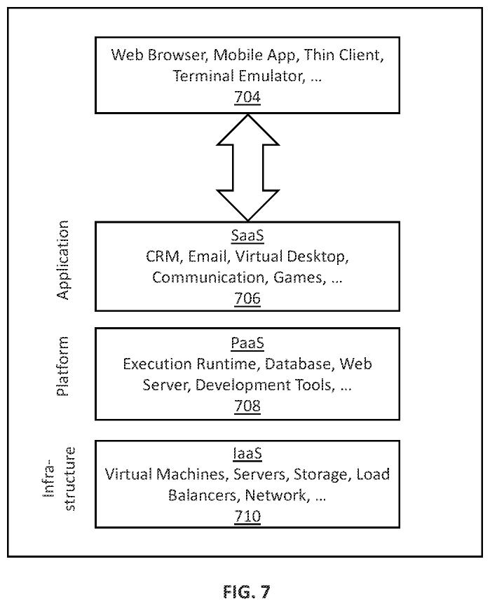

In some embodiments, the exemplary inventive computer-based systems/platforms, the exemplary inventive computer-based devices, and/or the exemplary inventive computer-based components of the present disclosure may be specifically configured to operate in a cloud computing/architecture 525 such as, but not limiting to: infrastructure a service (IaaS) 710, platform as a service (PaaS) 708, and/or software as a service (SaaS) 706 using a web browser, mobile app, thin client, terminal emulator or other endpoint 704. FIGS. 6 and 7 illustrate schematics of exemplary implementations of the cloud computing/architecture(s) in which the exemplary inventive computer-based systems/platforms, the exemplary inventive computer-based devices, and/or the exemplary inventive computer-based components of the present disclosure may be specifically configured to operate.

It is understood that at least one aspect/functionality of various embodiments described herein can be performed in real-time and/or dynamically. As used herein, the term “real-time” is directed to an event/action that can occur instantaneously or almost instantaneously in time when another event/action has occurred. For example, the “real-time processing,” “real-time computation,” and “real-time execution” all pertain to the performance of a computation during the actual time that the related physical process (e.g., a user interacting with an application on a mobile device) occurs, in order that results of the computation can be used in guiding the physical process.

As used herein, the term “dynamically” and term “automatically,” and their logical and/or linguistic relatives and/or derivatives, mean that certain events and/or actions can be triggered and/or occur without any human intervention. In some embodiments, events and/or actions in accordance with the present disclosure can be in real-time and/or based on a predetermined periodicity of at least one of: nanosecond, several nanoseconds, millisecond, several milliseconds, second, several seconds, minute, several minutes, hourly, several hours, daily, several days, weekly, monthly, etc.

As used herein, the term “runtime” corresponds to any behavior that is dynamically determined during an execution of a software application or at least a portion of software application.

In some embodiments, exemplary inventive, specially programmed computing systems and platforms with associated devices are configured to operate in the distributed network environment, communicating with one another over one or more suitable data communication networks (e.g., the Internet, satellite, etc.) and utilizing one or more suitable data communication protocols/modes such as, without limitation, IPX/SPX, X.25, AX.25, AppleTalk™, TCP/IP (e.g., HTTP), near-field wireless communication (NFC), RFID, Narrow Band Internet of Things (NBIOT), 3G, 4G, 5G, GSM, GPRS, WiFi, WiMax, CDMA, satellite, ZigBee, and other suitable communication modes.

In some embodiments, the NFC can represent a short-range wireless communications technology in which NFC-enabled devices are “swiped,” “bumped,” “tap” or otherwise moved in close proximity to communicate. In some embodiments, the NFC could include a set of short-range wireless technologies, typically requiring a distance of 10 cm or less. In some embodiments, the NFC may operate at 13.56 MHz on ISO/IEC 18000-3 air interface and at rates ranging from 106 kbit/s to 424 kbit/s. In some embodiments, the NFC can involve an initiator and a target; the initiator actively generates an RF field that can power a passive target. In some embodiment, this can enable NFC targets to take very simple form factors such as tags, stickers, key fobs, or cards that do not require batteries. In some embodiments, the NFC's peer-to-peer communication can be conducted when a plurality of NFC-enable devices (e.g., smartphones) within close proximity of each other.

The material disclosed herein may be implemented in software or firmware or a combination of them or as instructions stored on a machine-readable medium, which may be read and executed by one or more processors. A machine-readable medium may include any medium and/or mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others.

As used herein, the terms “computer engine” and “engine” identify at least one software component and/or a combination of at least one software component and at least one hardware component which are designed/programmed/configured to manage/control other software and/or hardware components (such as the libraries, software development kits (SDKs), objects, etc.).

Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. In some embodiments, the one or more processors may be implemented as a Complex Instruction Set Computer (CISC) or Reduced Instruction Set Computer (RISC) processors; x86 instruction set compatible processors, multi-core, or any other microprocessor or central processing unit (CPU). In various implementations, the one or more processors may be dual-core processor(s), dual-core mobile processor(s), and so forth.

Computer-related systems, computer systems, and systems, as used herein, include any combination of hardware and software. Examples of software may include software components, programs, applications, operating system software, middleware, firmware, software modules, routines, subroutines, functions, methods, procedures, software interfaces, application program interfaces (API), instruction sets, computer code, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that make the logic or processor. Of note, various embodiments described herein may, of course, be implemented using any appropriate hardware and/or computing software languages (e.g., C++, Objective-C, Swift, Java, JavaScript, Python, Perl, QT, etc.).

In some embodiments, one or more of illustrative computer-based systems or platforms of the present disclosure may include or be incorporated, partially or entirely into at least one personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth.

As used herein, term “server” should be understood to refer to a service point which provides processing, database, and communication facilities. By way of example, and not limitation, the term “server” can refer to a single, physical processor with associated communications and data storage and database facilities, or it can refer to a networked or clustered complex of processors and associated network and storage devices, as well as operating software and one or more database systems and application software that support the services provided by the server. Cloud servers are examples.

In some embodiments, as detailed herein, one or more of the computer-based systems of the present disclosure may obtain, manipulate, transfer, store, transform, generate, and/or output any digital object and/or data unit (e.g., from inside and/or outside of a particular application) that can be in any suitable form such as, without limitation, a file, a contact, a task, an email, a message, a map, an entire application (e.g., a calculator), data points, and other suitable data. In some embodiments, as detailed herein, one or more of the computer-based systems of the present disclosure may be implemented across one or more of various computer platforms such as, but not limited to: (1) FreeBSD, NetBSD, OpenBSD; (2) Linux; (3) Microsoft Windows™; (4) OpenVMS™; (5) OS X (MacOS™); (6) UNIX™; (7) Android; (8) iOS™; (9) Embedded Linux; (10) Tizen™; (11) WebOS™; (12) Adobe AIR™; (13) Binary Runtime Environment for Wireless (BREW™); (14) Cocoa™ (API); (15) Cocoa™ Touch; (16) Java™ Platforms; (17) JavaFX™; (18) QNX™; (19) Mono; (20) Google Blink; (21) Apple WebKit; (22) Mozilla Gecko™; (23) Mozilla XUL; (24) NET Framework; (25) Silverlight™; (26) Open Web Platform; (27) Oracle Database; (28) Qt™; (29) SAP NetWeaver™; (30) Smartface™; (31) Vexi™; (32) Kubernetes™ and (33) Windows Runtime (WinRT™) or other suitable computer platforms or any combination thereof. In some embodiments, illustrative computer-based systems or platforms of the present disclosure may be configured to utilize hardwired circuitry that may be used in place of or in combination with software instructions to implement features consistent with principles of the disclosure. Thus, implementations consistent with principles of the disclosure are not limited to any specific combination of hardware circuitry and software. For example, various embodiments may be embodied in many different ways as a software component such as, without limitation, a stand-alone software package, a combination of software packages, or it may be a software package incorporated as a “tool” in a larger software product.

For example, exemplary software specifically programmed in accordance with one or more principles of the present disclosure may be downloadable from a network, for example, a website, as a stand-alone product or as an add-in package for installation in an existing software application. For example, exemplary software specifically programmed in accordance with one or more principles of the present disclosure may also be available as a client-server software application, or as a web-enabled software application. For example, exemplary software specifically programmed in accordance with one or more principles of the present disclosure may also be embodied as a software package installed on a hardware device.

In some embodiments, illustrative computer-based systems or platforms of the present disclosure may be configured to handle numerous concurrent users that may be, but is not limited to, at least 100 (e.g., but not limited to, 100-999), at least 1,000 (e.g., but not limited to, 1,000-9,999), at least 10,000 (e.g., but not limited to, 10,000-99,999), at least 100,000 (e.g., but not limited to, 100,000-999,999), at least 1,000,000 (e.g., but not limited to, 1,000,000-9,999,999), at least 10,000,000 (e.g., but not limited to, 10,000,000-99,999,999), at least 100,000,000 (e.g., but not limited to, 100,000,000-999,999,999), at least 1,000,000,000 (e.g., but not limited to, 1,000,000,000-999,999,999,999), and so on.

In some embodiments, illustrative computer-based systems or platforms of the present disclosure may be configured to output to distinct, specifically programmed graphical user interface implementations of the present disclosure (e.g., a desktop, a web app., etc.). In various implementations of the present disclosure, a final output may be displayed on a displaying screen which may be, without limitation, a screen of a computer, a screen of a mobile device, or the like. In various implementations, the display may be a holographic display. In various implementations, the display may be a transparent surface that may receive a visual projection. Such projections may convey various forms of information, images, or objects. For example, such projections may be a visual overlay for a mobile augmented reality (MAR) application.

In some embodiments, illustrative computer-based systems or platforms of the present disclosure may be configured to be utilized in various applications which may include, but not limited to, gaming, mobile-device games, video chats, video conferences, live video streaming, video streaming and/or augmented reality applications, mobile-device messenger applications, and others similarly suitable computer-device applications.

As used herein, the term “mobile electronic device,” or the like, may refer to any portable electronic device that may or may not be enabled with location tracking functionality (e.g., MAC address, Internet Protocol (IP) address, or the like). For example, a mobile electronic device can include, but is not limited to, a mobile phone, Personal Digital Assistant (PDA), Blackberry™ Pager, Smartphone, or any other reasonable mobile electronic device.

As used herein, terms “proximity detection,” “locating,” “location data,” “location information,” and “location tracking” refer to any form of location tracking technology or locating method that can be used to provide a location of, for example, a particular computing device, system or platform of the present disclosure and any associated computing devices, based at least in part on one or more of the following techniques and devices, without limitation: accelerometer(s), gyroscope(s), Global Positioning Systems (GPS); GPS accessed using Bluetooth™; GPS accessed using any reasonable form of wireless and non-wireless communication; WiFi™ server location data; Bluetooth™ based location data; triangulation such as, but not limited to, network based triangulation, WiFi™ server information based triangulation, Bluetooth™ server information based triangulation; Cell Identification based triangulation, Enhanced Cell Identification based triangulation, Uplink-Time difference of arrival (U-TDOA) based triangulation, Time of arrival (TOA) based triangulation, Angle of arrival (AOA) based triangulation; techniques and systems using a geographic coordinate system such as, but not limited to, longitudinal and latitudinal based, geodesic height based, Cartesian coordinates based; Radio Frequency Identification such as, but not limited to, Long range RFID, Short range RFID; using any form of RFID tag such as, but not limited to active RFID tags, passive RFID tags, battery assisted passive RFID tags; or any other reasonable way to determine location. For ease, at times the above variations are not listed or are only partially listed; this is in no way meant to be a limitation.

As used herein, terms “cloud,” “Internet cloud,” “cloud computing,” “cloud architecture,” and similar terms correspond to at least one of the following: (1) a large number of computers connected through a real-time communication network (e.g., Internet); (2) providing the ability to run a program or application on many connected computers (e.g., physical machines, virtual machines (VMs)) at the same time; (3) network-based services, which appear to be provided by real server hardware, and are in fact served up by virtual hardware (e.g., virtual servers), simulated by software running on one or more real machines (e.g., allowing to be moved around and scaled up (or down) on the fly without affecting the end user).

In some embodiments, the illustrative computer-based systems or platforms of the present disclosure may be configured to securely store and/or transmit data by utilizing one or more of encryption techniques (e.g., private/public key pair, Triple Data Encryption Standard (3DES), block cipher algorithms (e.g., IDEA, RC2, RC5, CAST and Skipjack), cryptographic hash algorithms (e.g., MD5, RIPEMD-160, RTRO, SHA-1, SHA-2, Tiger (TTH), WHIRLPOOL, RNGs).

As used herein, the term “user” shall have a meaning of at least one user. In some embodiments, the terms “user”, “subscriber” “consumer” or “customer” should be understood to refer to a user of an application or applications as described herein and/or a consumer of data supplied by a data provider. By way of example, and not limitation, the terms “user” or “subscriber” can refer to a person who receives data provided by the data or service provider over the Internet in a browser session, or can refer to an automated software application which receives the data and stores or processes the data.

The aforementioned examples are, of course, illustrative and not restrictive.

At least some aspects of the present disclosure will now be described with reference to the following numbered clauses.
1. A method including:
receiving, by at least one processor, event data including at least one event data entry that represents at least one event;
   where the at least one event data entry includes at least one event attribute;
utilizing, by the at least one processor, a feedback machine learning model to predict an average feedback attribute and an average feedback variability attribute based at least in part on the event data;
   where the average feedback attribute includes an average event feedback percentage;
   where the average feedback variability attribute includes an average event feedback variability percentage;
generating, by the at least one processor, a feedback data entry in a user profile to store the average feedback attribute and the average feedback variability attribute in association with the user profile;
receiving, by the at least one processor, at least one new event indication associated with the user profile, where the at least one new event indication indicates at least one new event and at least one new event attribute of the at least one new event;
generating, by the at least one processor, a feedback probability distribution based at least in part on the at least one new event attribute, the average feedback attribute and the average feedback variability attribute of the average feedback data entry;
generating, by the at least one processor, a new event feedback for at least one new event based at least in part on the at least one new event attribute and at least one random selection from the feedback probability distribution; and
instructing, by the at least one processor, to display the new event feedback for the at least one new event indication on a computing device associated with the user profile.
2. The method of clause 1, further including determining, by the at least one processor, a target variability of the average feedback attribute including at least one of:
a maximum feedback rate,
a minimum feedback rate, or
a number of standard deviations.
3. The method of clause 2, further including generating, by the at least one processor, a user-specific variable rate feedbacks record linked to the user profile, where the user-specific variable rate feedbacks include the average feedback attribute and a target variability attribute specifying the target variability.
4. The method of clause 1, where the average feedback attribute includes at least one:
a target frequency including an average frequency of applying the at least one new feedback in response to the at least one new event, or
a target feedback quantity an average quantity of the at least one new feedback in response to the at least one new event.
5. The method of clause 1, further including:
determining, by the at least one processor, at least one engagement metric measuring user engagement based at least in part on the at least new event data entry;
comparing, by the at least one processor, the at least one engagement metric with at least one threshold engagement value; and
determining, by the at least one processor, a modification to the average feedback attribute based at least in part on comparing the at least one engagement metric with at least one threshold engagement value.
6. The method of clause 5, further including utilizing, by the at least one processor, the feedback machine learning model to determine the modification to the average feedback attribute based at least in part on model parameters and the least one engagement metric.
7. The method of clause 6, where the feedback machine learning model includes at least one reinforcement model.
8. The method of clause 6, further including:
producing, by the at least one processor, a training dataset that correlates the event data with previous modifications to the average feedback attribute; and
training, by the at least one processor, the feedback machine learning model based at least in part on the training dataset.
9. The method of clause 1, where the probability distribution includes a normal distribution.
10. The method of clause 1, where the probability distribution includes a gamma distribution.
11. A system including:
at least one processor configured to execute software instructions, where upon execution the software instructions cause the at least one processor to:
   receive event data including at least one event data entry that represents at least one event;
      where the at least one event data entry includes at least one event attribute;
   utilize a feedback machine learning model to predict an average feedback attribute and an average feedback variability attribute based at least in part on the event data;
      where the average feedback attribute includes an average event feedback percentage;
      where the average feedback variability attribute includes an average event feedback variability percentage;
   generate a feedback data entry in a user profile to store the average feedback attribute and the average feedback variability attribute in association with the user profile;
   receive at least one new event indication associated with the user profile,
      where the at least one new event indication indicates at least one new event and at least one new event attribute of the at least one new event;
   generate a feedback probability distribution based at least in part on the at least one new event attribute, the average feedback attribute and the average feedback variability attribute of the average feedback data entry;
   generate a new event feedback for at least one new event based at least in part on the at least one new event attribute and at least one random selection from the feedback probability distribution; and
   instruct to display at least one the new event feedback for the at least one new event indication on a computing device associated with the user profile.
12. The system of clause 11, where the at least one processor is further configured to execute software instructions that, upon execution, further cause the at least one processor to determine a target variability of the average feedback attribute include at least one of:
a maximum feedback rate,
a minimum feedback rate, or
a number of standard deviations.
13. The system of clause 12, where the at least one processor is further configured to execute software instructions that, upon execution, further cause the at least one processor to generate a user-specific variable rate feedbacks record linked to the user profile, where the user-specific variable rate feedbacks include the average feedback attribute and a target variability attribute specifying the target variability.
14. The system of clause 11, where the average feedback attribute includes at least one:
a target frequency including an average frequency of applying the at least one new feedback in response to the at least one new event, or
a target feedback quantity an average quantity of the at least one new feedback in response to the at least one new event.
15. The system of clause 11, where the at least one processor is further configured to execute software instructions that, upon execution, further cause the at least one processor to:
determine at least one engagement metric measure user engagement based at least in part on the at least new event data entry;
compare the at least one engagement metric with at least one threshold engagement value; and
determine a modification to the average feedback attribute based at least in part on comparing the at least one engagement metric with at least one threshold engagement value.
16. The system of clause 15, where the at least one processor is further configured to execute software instructions that, upon execution, further cause the at least one processor to utilize the feedback machine learning model to determine the modification to the average feedback attribute based at least in part on model parameters and the least one engagement metric.
17. The system of clause 16, where the feedback machine learning model includes at least one reinforcement model.
18. The system of clause 16, where the at least one processor is further configured to execute software instructions that, upon execution, further cause the at least one processor to:
produce a training dataset that correlates the event data with previous modifications to the average feedback attribute; and
train the feedback machine learning model based at least in part on the training dataset.
19. The system of clause 11, where the probability distribution includes a normal distribution.
20. A method including:
receiving, by the at least one processor, at least one new event indication associated with a user profile,
   where the at least one new event indication indicates at least one new event and at least one new event attribute of the at least one new event;
accessing, by the at least one processor, an average feedback attribute and an average feedback variability attribute associated with the user profile;
   where the average feedback attribute includes an average event feedback percentage;
   where the average feedback variability attribute includes an average event feedback variability percentage;
generating, by the at least one processor, a feedback probability distribution based at least in part on:
   i) the at least one new event attribute,
   ii) the average feedback attribute, and
   iii) the average feedback variability attribute of the feedback data entry;
generating, by the at least one processor, a new event feedback for at least one new event based at least in part on:
   i) the at least one new event attribute, and
   ii) at least one random selection from the feedback probability distribution; and
updating, by the at least one processor, the user profile with a feedback score indicative of the new event feedback.

Publications cited throughout this document are hereby incorporated by reference in their entirety. While one or more embodiments of the present disclosure have been described, it is understood that these embodiments are illustrative only, and not restrictive, and that many modifications may become apparent to those of ordinary skill in the art, including that various embodiments of the inventive methodologies, the illustrative systems and platforms, and the illustrative devices described herein can be utilized in any combination with each other. Further still, the various steps may be carried out in any desired order (and any desired steps may be added and/or any desired steps may be eliminated).

1. A method comprising:
receiving, by at least one processor, event data comprising at least one event data entry that represents at least one event;
wherein the at least one event data entry comprises at least one event attribute;
utilizing, by the at least one processor, a feedback machine learning model to predict an average feedback attribute and an average feedback variability attribute based at least in part on the event data;
wherein the average feedback attribute comprises an average event feedback percentage;
wherein the average feedback variability attribute comprises an average event feedback variability percentage;
generating, by the at least one processor, a feedback data entry in a user profile to store the average feedback attribute and the average feedback variability attribute in association with the user profile;
receiving, by the at least one processor, at least one new event indication associated with the user profile,
wherein the at least one new event indication indicates at least one new event and at least one new event attribute of the at least one new event;
generating, by the at least one processor, a feedback probability distribution based at least in part on:
iv) the at least one new event attribute,
v) the average feedback attribute, and
vi) the average feedback variability attribute of the feedback data entry;
generating, by the at least one processor, a new event feedback for at least one new event based at least in part on:
iii) the at least one new event attribute, and
iv) at least one random selection from the feedback probability distribution; and
instructing, by the at least one processor, to display the new event feedback for the at least one new event indication on a computing device associated with the user profile.

2. The method of claim 1, further comprising determining, by the at least one processor, a target variability of the average feedback attribute comprising at least one of:
a maximum feedback rate,
a minimum feedback rate, or
a number of standard deviations.

3. The method of claim 2, further comprising generating, by the at least one processor, a user-specific variable rate feedback record linked to the user profile, wherein the user-specific variable rate feedback record comprises the average feedback attribute and a target variability attribute specifying the target variability.

4. The method of claim 1, wherein the average feedback attribute comprises at least one:
a target frequency comprising an average frequency of applying the new event feedback in response to the at least one new event, or
a target feedback quantity an average quantity of the new event feedback in response to the at least one new event.

5. The method of claim 1, further comprising:
determining, by the at least one processor, at least one engagement metric measuring user engagement based at least in part on the at least one new event;
comparing, by the at least one processor, the at least one engagement metric with at least one threshold engagement value; and
determining, by the at least one processor, a modification to the average feedback attribute based at least in part on comparing the at least one engagement metric with at least one threshold engagement value.

6. The method of claim 5, further comprising utilizing, by the at least one processor, the feedback machine learning model to determine the modification to the average feedback attribute based at least in part on model parameters and the at least one engagement metric.

7. The method of claim 6, wherein the feedback machine learning model comprises at least one reinforcement model.

8. The method of claim 6, further comprising:
producing, by the at least one processor, a training dataset that correlates the event data with previous modifications to the average feedback attribute; and
training, by the at least one processor, the feedback machine learning model based at least in part on the training dataset.

9. The method of claim 1, wherein the feedback probability distribution comprises a normal distribution.

10. The method of claim 1, wherein the feedback probability distribution comprises a gamma distribution.

11. A system comprising:
at least one processor configured to execute software instructions, wherein upon execution the software instructions cause the at least one processor to:
receive event data comprising at least one event data entry that represents at least one event;
wherein the at least one event data entry comprises at least one event attribute;
utilize a feedback machine learning model to predict an average feedback attribute and an average feedback variability attribute based at least in part on the event data;
wherein the average feedback attribute comprises an average event feedback percentage;
wherein the average feedback variability attribute comprises an average event feedback variability percentage;
generate a feedback data entry in a user profile to store the average feedback attribute and the average feedback variability attribute in association with the user profile;
receive at least one new event indication associated with the user profile,
wherein the at least one new event indication indicates at least one new event and at least one new event attribute of the at least one new event;
generate a feedback probability distribution based at least in part on the at least one new event attribute, the average feedback attribute and the average feedback variability attribute of the feedback data entry;
generate a new event feedback for at least one new event based at least in part on the at least one new event attribute and at least one random selection from the feedback probability distribution; and
instruct to display at least one the new event feedback for the at least one new event indication on a computing device associated with the user profile.

12. The system of claim 11, wherein the at least one processor is further configured to execute software instructions that, upon execution, further cause the at least one processor to determine a target variability of the average feedback attribute comprise at least one of:
a maximum feedback rate,
a minimum feedback rate, or
a number of standard deviations.

13. The system of claim 12, wherein the at least one processor is further configured to execute software instructions that, upon execution, further cause the at least one processor to generate a user-specific variable rate feedbacks record linked to the user profile,
wherein the user-specific variable rate feedbacks record comprises the average feedback attribute and a target variability attribute specifying the target variability.

14. The system of claim 11, wherein the average feedback attribute comprises at least one:
a target frequency comprise an average frequency of applying the new event feedback in response to the at least one new event, or
a target feedback quantity an average quantity of the new event feedback in response to the at least one new event.

15. The system of claim 11, wherein the at least one processor is further configured to execute software instructions that, upon execution, further cause the at least one processor to:
determine at least one engagement metric measuring user engagement based at least in part on the at least one new event;
compare the at least one engagement metric with at least one threshold engagement value; and
determine a modification to the average feedback attribute based at least in part on comparing the at least one engagement metric with at least one threshold engagement value.

16. The system of claim 15, wherein the at least one processor is further configured to execute software instructions that, upon execution, further cause the at least one processor to utilize the feedback machine learning model to determine the modification to the average feedback attribute based at least in part on model parameters and the least one engagement metric.

17. The system of claim 16, wherein the feedback machine learning model comprises at least one reinforcement model.

18. The system of claim 16, wherein the at least one processor is further configured to execute software instructions that, upon execution, further cause the at least one processor to:
produce a training dataset that correlates the event data with previous modifications to the average feedback attribute; and
train the feedback machine learning model based at least in part on the training dataset.

19. The system of claim 11, wherein the feedback probability distribution comprises a normal distribution.

20. A method comprising:
receiving, by the at least one processor, at least one new event indication associated with a user profile,
wherein the at least one new event indication indicates at least one new event and at least one new event attribute of the at least one new event;
accessing, by the at least one processor, an average feedback attribute and an average feedback variability attribute associated with the user profile;
wherein the average feedback attribute comprises an average event feedback percentage;
wherein the average feedback variability attribute comprises an average event feedback variability percentage;
generating, by the at least one processor, a feedback probability distribution based at least in part on:
vii) the at least one new event attribute,
viii) the average feedback attribute, and
ix) the average feedback variability attribute of the feedback data entry;
generating, by the at least one processor, a new event feedback for at least one new event based at least in part on:
v) the at least one new event attribute, and
vi) at least one random selection from the feedback probability distribution; and
updating, by the at least one processor, the user profile with a feedback score indicative of the new event feedback.
